(19) United States
(12) Patent Application Publication
(10) Pub. No.: US 2016/0338332 A1
(43) Pub. Date: Nov. 24, 2016

(54) Cricket keeper for baiting a sport fishing hook

(71) Applicants: Todd Osting, Louisville, KY (US); Jamie Pryor, Louisville, KY (US)

(72) Inventors: Todd Osting, Louisville, KY (US); Jamie Pryor, Louisville, KY (US)

(21) Appl. No.: 15/161,899

(22) Filed: May 23, 2016

Related U.S. Application Data
(60) Provisional application No. 62/164,857, filed on May 21, 2015.

(51) Int. Cl. A01K 97/04; A01K 99/00

(52) U.S. Cl. CPC A01K 97/04; A01K 99/00

(57) ABSTRACT

A cricket keeper for baiting a sport fishing hook contains a large plurality of crickets as live bait, and provides a conical lid with a narrow capped opening at its peak, where a single cricket may become trapped when the cricket keeper is inverted. A slot is provided in the side of the opening, enabling the user to insert a hook through the slot to impale a trapped cricket without touching the cricket. Then invert the cricket hooker back up right lifting the hook towards the top. Simply remove the cap lift out the hook with the cricket securely impaled.

### CROSS-REFERENCE TO RELATED APPLICATIONS

This Application claims the benefit of U.S. Provisional Application No. 62/164,857, filed May 21, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to sport fishing tackle and equipment, and in particular to a cricket keeper for baiting a sport fishing hook. Using crickets as live bait has proven to be very effective for many sport fishermen. Unfortunately, the crickets are difficult to handle and can be unpleasant for some, particularly women and children. These participants are forced to rely on others to bait their hooks for them. Cricket keepers have been developed which will hold the crickets, and provide a narrow opening where a single cricket may be grasped for the fisherman to insert a hook. Unfortunately, when the lid is removed, other crickets may jump out and escape.

A search of the prior art reveals various bait keeping and hook baiting devices which have been developed to provide the sport fisherman a means for the keeping of a quantity of live bait, particularly crickets, and the baiting of a hook with the live bait. None are closely related to the present invention, but several include features which resemble those of the present invention. Each has proven to be less than satisfactory in its own way.

Baiting system for a fishing hook, U.S. Pat. No. 6,438,892 (filed Mar. 29, 2000), provides a baiting system for a fishing hook which controls, directs and holds live fishing bait, specifically leeches, in a confined space. The system provides for proper threading on a fishing hook without requiring one's hands or fingers to touch the live bait. The system includes a funnel with a stem, a stopper to be inserted into the funnel at the stem, a soft plastic tubing engaged over the lower end of the stem, and at the lower end of the plastic tubing at least one hole followed by a slit, with optional opposing hole and slit, and a binder clip at the bottom to trap the bait. The bait, such as a leech, is dropped into the funnel and positioned by the stopper to slide tail first into the plastic tubing. The barb of the fish hook is inserted through the hole, into the tail of the bait, and then the binder clip is removed and the hooked bait is pulled down through the slit of the plastic tubing.

Cricket dispensing and hooking device, U.S. Pat. No. 4,989,362 (filed Jun. 5, 1989), provides a live bait dispenser for receiving and retaining a plurality of crickets or other live fish bait and comprising devices to allow for the transfer of said bait to a container from which they cannot return and also a means by which the operator may hook said bait and remove it from the device without allowing other baits to escape.

Cricket dispenser, U.S. Pat. No. 4,815,230 (filed Feb. 16, 1988), provides a cricket dispensing nozzle having a generally annular open end for communicating with the source of crickets. Four resilient prongs emerge from the annular member and converge towards a dispensing opening in a continuous manner. Spaces between the four prongs permit insertion of a hook, both through that space and through the space below so that the hook may be passed through the cricket twice and the cricket removed from the nozzle without otherwise damaging the cricket.

Hook baiting machine, U.S. Pat. No. 4,015,359 (filed Jul. 18, 1975), provides an apparatus for baiting fishing hooks attached at spaced intervals by snoods to a long line comprising guide means for receiving the lines, snoods and eyes of the hooks to channel them longitudinally and unobstructedly through said apparatus and restrict them against lateral displacement out of the guide means. Orienting and tensioning means, laterally offset from the guide means, momentarily engage each hook to progressively rotatably orient it while increasing the tension on the hook and its associated snood. As the hook then leaves the orienting and tensioning means, it flips into a baiting chamber to securely impale bait supplied thereto. The baited hook leaves the apparatus together with the snood and main line, thus reducing the chance of loss of bait by a whiplash action, in which the hook and snood have to be separated from the main line before passing through the baiter. In addition, according to the present invention, the hook orientation is carefully controlled from the moment the hook enters the apparatus to the moment it leaves the orienting and tensioning means, to ensure effective baiting.

Method and baiting machine for baiting fishing hooks, U.S. Pat. No. 5,934,003 (priority May 6, 1996), provides a method for baiting fishing hooks by a baiting machine including a baiting station, wherein fishing hooks are pulled past the baiting station by a line which is attached in the hook's eye. The method includes the steps of threading bait at a first end section thereof, bringing the point of the hook into engagement with a second end section of the bait opposite the first end section during an introductory threading of the hook on to the bait, rotating the bait in a first direction about the spike under the influence of the force exerted on the bait by the hook, while the hook simultaneously continues to be threaded on the bait, and rotating the hook in a direction opposite to the first direction by pulling it off the line, until the bait has been threaded on to the bend of the hook. The invention also relates to a baiting machine for implementation of the method. The baiting machine includes a base on which the shank of the hook can slide, a bait holder with a support side which faces in the pulling direction of the hook, and a holding arm which can be resiliently pressed against the support side. From the section of the support side which faces away from the base, a spike projects towards the holding arm, on which spike the bait can be impaled.

Baiting machine for trawl line fishing using entire fishes, U.S. Pat. No. 4,644,677 (filed Sep. 30, 1985), provides a machine which combines a guide known for the guiding of the point of the fish hooks, a corridor for the introduction of the baiting fish which is perpendicular to the trajectory of the fish hook point, a retractable wall prolongating the wall of the corridor on the downstream side of the trajectory of the fish hook and a second wall perpendicular to the first, said second wall being prolongated by an arm which can be caught by the fish hook in order to pivot the retractable wall about a pivoting axis situated toward the corridor and downstream with respect to the trajectory of the fish hook and an oblique ramp pushing back the head of the bait introduced along the longitudinal direction of the corridor toward the second wall of the retractable wall. The machine is usable for trawl line fishing.

Some of the prior art inventions require the user to physically handle the bait while others, although manipulating the bait mechanically, require very skilled and well-practiced handling by the user. Other prior art inventions fail to accommodate crickets entirely as a type of bait, and some are intended for large scale commercial fishing operations. The present invention has been developed for the purpose of addressing and resolving these disadvantages. A cricket keeper for baiting a sport fishing hook, providing a cap on the opening and a slot where a hook may be inserted into the cricket, such that it may be easily operated by a novice user or a child without handling the cricket, would resolve all these problems.

### SUMMARY OF THE INVENTION

Accordingly, the invention is directed to a cricket keeper for baiting a sport fishing hook. The cricket keeper may be used to contain a large plurality of crickets as live bait, and provides a conical lid with a narrow capped opening at its peak, where a single cricket may become trapped when the cricket keeper is inverted. A slot is provided in the side of the opening, enabling the user to insert a hook through the slot to impale a trapped cricket without touching the cricket. The user may then remove the cap from the opening and lift out the hook with the cricket securely impaled.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of the first exemplary embodiment, displaying the cricket keeper 10, the air holes 11, the lid 12, the opening 13, the cap 14, and the slot 15.

FIG. 2 is a side view of the first exemplary embodiment, displaying the cricket keeper 10, the lid 12, the opening 13, and the cap 14.

FIG. 3 is a front view of the first exemplary embodiment with the cap removed, displaying the cricket keeper 10, the air holes 11, the lid 12, the opening 13, the cap 14, and the slot 15.

FIG. 4 is a front view of the lid of the first exemplary embodiment, displaying the lid 12, the opening 13, the cap 14, and the slot 15.

FIG. 5 is a front perspective view of the first exemplary embodiment, displaying the cricket keeper 10, and the lid 12.

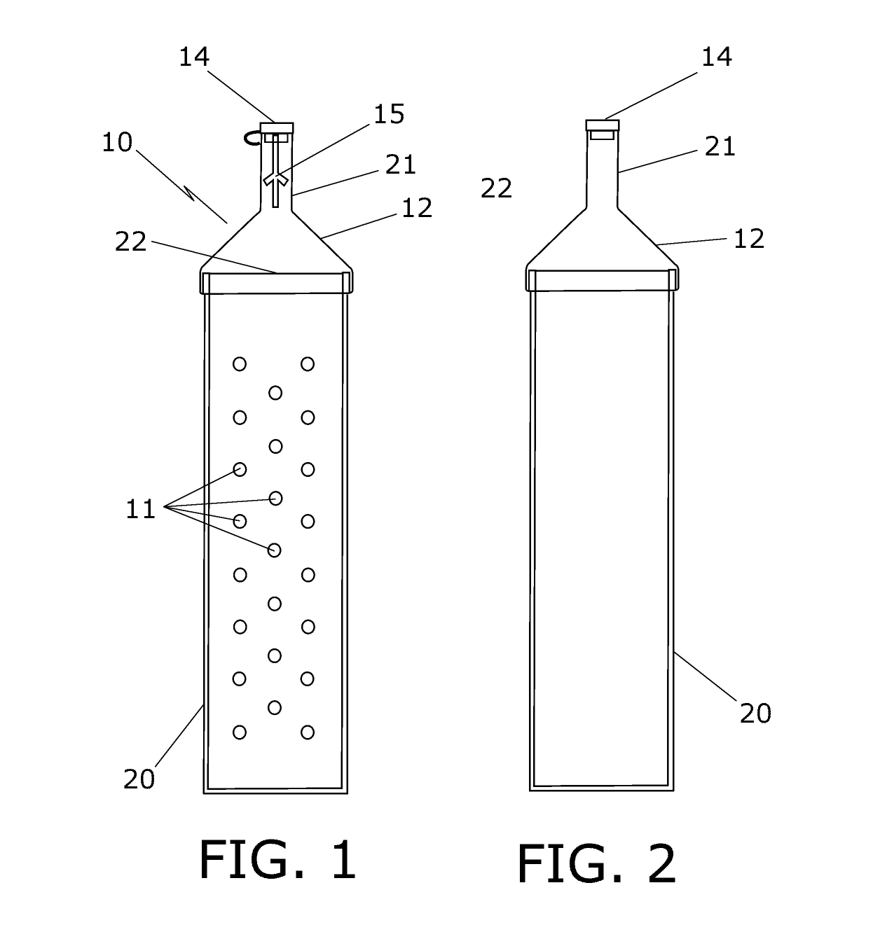

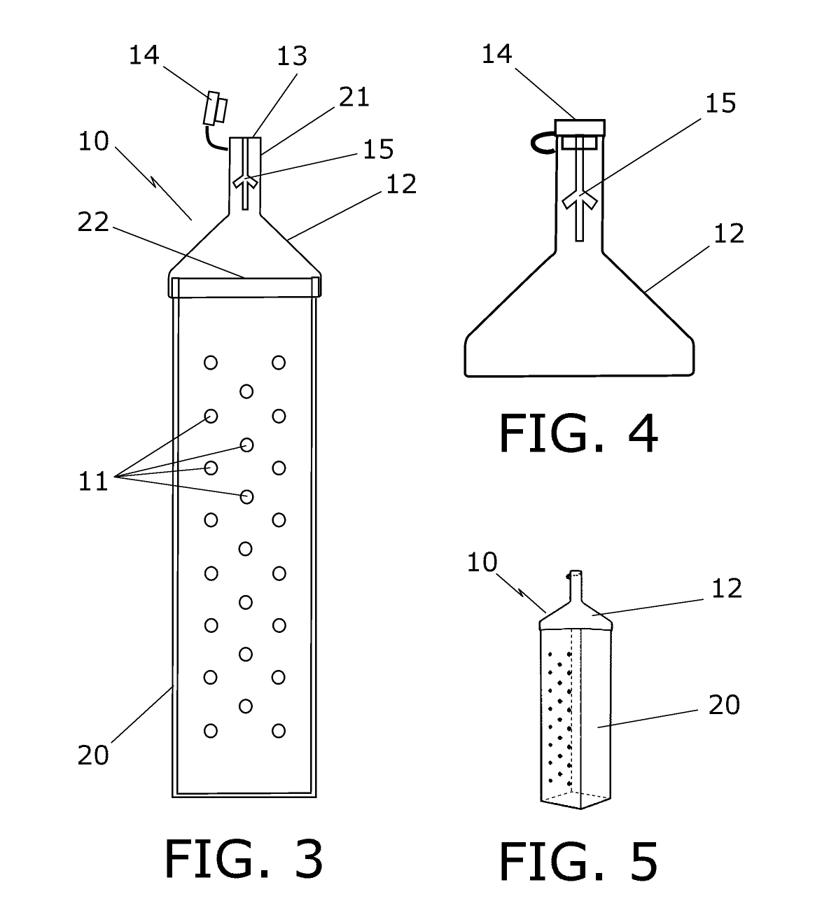

### DETAILED DESCRIPTION OF THE INVENTION

Referring now to the invention in more detail, the invention is directed to a cricket keeper 10 for baiting a sport fishing hook.

The first exemplary embodiment is comprised of a cricket keeper 10, which may be used to contain a large plurality of crickets as live bait. The cricket keeper body 20 having an open end 22. The body 20 is preferably tall and rectangular, similar in shape to a milk carton, and provides air holes 11 on the front and rear surfaces. A conical lid 12 which terminates in a cylinder shaft 21. The cylinder shaft 21 terminates with a narrow opening 13 at its peak. A single cricket may become trapped in the cylinder shaft 21 when the cricket keeper 10 is inverted. A slot 15 is provided in the side of the cylinder shaft 21, enabling the user to insert a hook through the slot 15 to impale a trapped cricket without touching the cricket. The slot 15 is shaped such that any hook may pass through the slot 15 (i.e. a standard single hook, double hook, treble hook, or any other type of hook). The slot 15 extends to the end of the cylinder shaft 21 such that the hook may pass out of the opening 13 without being removed back through the slot 15.

The cricket keeper 10 is preferably transparent or translucent, enabling the user to clearly see how many crickets are left to be used as bait, and whether a cricket has become trapped in the opening 13. The cap 14 is tethered to the lid 12 to prevent loss of the cap 14, enabling easy one-handed recovery and replacement of the cap 14 on the opening 13 after the cricket has been removed.

To use the first exemplary embodiment, the user removes the lid 12 and inserts a plurality of live crickets into the cricket keeper 10. When preparing to bait a hook, the user inverts the cricket keeper 10, gently shaking the cricket keeper 10 until a cricket becomes trapped in the cylinder shaft 13. The user may then right the cricket keeper 10, insert a hook through the slot 15, impale the cricket on the hook, remove the cap 14 from the opening 13, and lift out the hook with the cricket securely impaled out through the opening 13. Finally, the user may replace the cap 14.

The cricket keeper 10 and the lid 12 are preferably manufactured from a rigid, durable material which is shatterproof and transparent or translucent, such as plastic or methacrylate. The cap 14 and tether are preferably manufactured from a flexible, durable material, such as plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A cricket keeper, comprising:
a. a body having an open end;
b. a conical lid;
c. said conical lid being sized and shaped to fit over the open end of the body and terminating in a cylindrical shaft opposite the body;
d. said cylindrical shaft terminating in an opening opposite the conical lid;
e. a slot in a side of the cylindrical shaft;
f. said slot being sized and shaped such that a hook may pass through the slot into the cylindrical shaft; and
g. a cap being sized and shaped to fit snuggly within the opening such that the lid removably seals the opening.

2. The cricket keeper of claim 1, wherein the body, conical lid, and cylindrical shaft are transparent or translucent.

3. The cricket keeper of claim 1, wherein the cap is tethered to the cricket keeper.

4. The cricket keeper of claim 1, wherein the body has a height greater than a width.

5. The cricket keeper of claim 4, wherein the body is rectangular in shape.

6. The cricket keeper of claim 2, wherein the body has a height greater than a width.

7. The cricket keeper of claim 6, wherein the body is rectangular in shape.

8. The cricket keeper of claim 1, wherein the body comprises a plurality of air holes; said air holes being large enough to allow the passage of air but small enough to entrap an insect.

9. The cricket keeper of claim 5, wherein the body comprises a plurality of air holes; said air holes being large enough to allow the passage of air but small enough to entrap an insect.

10. The cricket keeper of claim 7, wherein the body comprises a plurality of air holes; said air holes being large enough to allow the passage of air but small enough to entrap an insect.

11. A method of using the cricket keeper of claim 1, comprising: a user removes the conical lid; the user places a plurality of live crickets within the body through the open end; the user attaches the conical lid; the user inverts the cricket keeper such that one of the plurality of live crickets enters the cylindrical shaft; the user turns the cricket keeper upright such that all but the one of the plurality of crickets return to the body; the user slides a hook through the slot on the side of the cylindrical shaft; the user impales the one cricket with the hook; the user removes the cap; the user pulls the hook through the opening; and the user replaces the cap.

12. The method of using the cricket keeper of claim 11, wherein the body, conical lid, and cylindrical shaft are transparent or translucent.

13. The method of using the cricket keeper of claim 11, wherein the cap is tethered to the cricket keeper.

14. The method of using the cricket keeper of claim 11, wherein the body has a height greater than a width.

15. The method of using the cricket keeper of claim 14, wherein the body is rectangular in shape.

16. The method of using the cricket keeper of claim 12, wherein the body has a height greater than a width.

17. The method of using the cricket keeper of claim 16, wherein the body is rectangular in shape.

18. The method of using the cricket keeper of claim 11, wherein the body comprises a plurality of air holes; said air holes being large enough to allow the passage of air but small enough to entrap an insect.

19. The method of using the cricket keeper of claim 15, wherein the body comprises a plurality of air holes; said air holes being large enough to allow the passage of air but small enough to entrap an insect.

20. The method of using the cricket keeper of claim 17, wherein the body comprises a plurality of air holes; said air holes being large enough to allow the passage of air but small enough to entrap an insect.
